(19) United States
(12) Patent Application Publication
(10) Pub. No.: US 2014/0344592 A1
(43) Pub. Date: Nov. 20, 2014

(54) METHODS AND APPARATUS FOR POWERING UP AN INTEGRATED CIRCUIT

(71) Applicant: ADVANCED MICRO DEVICES, INC., Sunnyvale, CA (US)

(72) Inventor: Sebastien Nussbaum, Lexington, MA (US)

(73) Assignee: ADVANCED MICRO DEVICES, INC., Sunnyvale, CA (US)

(21) Appl. No.: 14/281,957

(22) Filed: May 20, 2014

Related U.S. Application Data
(60) Provisional application No. 61/825,243, filed on May 20, 2013.

(51) Int. Cl. G06F 1/26

(52) U.S. Cl. CPC G06F 1/26
USPC 713/300

(57) ABSTRACT

A power supply (406) supplies electrical power to a first portion (302) of an integrated circuit (209) (e.g., a portion designed to operate in a relatively wide temperature range). The first portion (302) of the integrated circuit (209) includes an on-die temperature sensor (306). If the first portion (402) is above a first temperature threshold (e.g., 0° C.), the power supply (406) also supplies electrical power to a second portion (304) of the integrated circuit (209) (e.g., a portion designed to operate in a relatively narrow temperature range). However, if the first portion (302) of the integrated circuit (209) is not above the first temperature threshold, the power supply (406) continues to only supply electrical power to the first portion (302) of the integrated circuit (209). In this manner, the integrated circuit (209) is less likely to malfunction and/or create a security problem.

### RELATED APPLICATION

This application claims priority to Provisional Application Ser. No. 61/825,243, filed on May 20, 2013, having inventor Sebastien Nussbaum, titled “METHODS AND APPARATUS FOR POWERING UP AN INTEGRATED CIRCUIT”, and is incorporated herein by reference.

### TECHNICAL FIELD

The present disclosure relates in general to computing devices, and, in particular, to methods and apparatus for powering up an integrated circuit.

### BACKGROUND

Integrated circuits are typically designed to operate within a certain temperature range. For example, an integrated circuit may be specified to operate properly from −55° C. to +125° C. (military grade), from 0° C. to +70° C. (commercial grade) or from −40° C. to +85° C. (industrial grade). At extreme hot and cold temperatures beyond the normal range for a particular integrated circuit, the integrated circuit typically will not operate at all and may be damaged.

However, at certain hot and/or cold temperatures near, but outside, the specified range of normal operating temperatures for a particular computing device, an integrated circuit in the computing device may partially operate and exhibit unintended behavior. In this mode, computing devices using the integrated circuit may malfunction. In some cases, the malfunction may lead to a security problem such as exposed passwords, etc.

### BRIEF DESCRIPTION OF THE DRAWINGS

FIG. 1 is a block diagram of an example network communication system.

FIG. 2 is a block diagram of an example electronic device incorporating an integrated circuit.

FIG. 3 is a block diagram of an example integrated circuit employing an example power up circuit.

FIG. 4 is a block diagram of another example integrated circuit employing an example power up circuit.

FIG. 5 is a flowchart of an example process for powering up an integrated circuit.

FIG. 6 is a block diagram of example temperature specifications for two different portions of the integrated circuit.

FIG. 7 is a flowchart of another example process for powering up an integrated circuit.

### DETAILED DESCRIPTION OF THE PREFERRED EMBODIMENTS

Briefly, methods and apparatus for powering up an computing device (e.g., a device including a CPU, GPU, and/or memory) are disclosed. In an embodiment, the integrated circuit includes a first portion (e.g., designed for normal operation in a relatively wide temperature range) and a second portion (e.g., designed for normal operation in a relatively narrow temperature range within the relatively wide temperature range). The first portion includes a temperature sensor (e.g., an on-die temperature sensor), and the second portion includes a reset input (e.g., which determines if a CPU can execute). The first portion is structured to hold the reset input at a non-operating level if the temperature sensor indicates that a temperature of the first portion is below a first temperature threshold (e.g., 0° C.). The first portion is also structured to hold the reset input at an operating level if the temperature sensor indicates that the temperature of the first portion is above the first temperature threshold (e.g., 0° C.).

Among other features, integrated circuits that power up different portions of the integrated circuit at different times (e.g., after self-heating) as described herein are less likely to malfunction and/or create a security problem by operating at a temperature where the integrated circuit only partially functions.

In one example, the integrated circuit of also includes a heating element structured to heat the first portion and the second portion if the temperature sensor indicates that the temperature of the first portion is below the first temperature threshold. In one example, the second portion is further structured to hold the reset input at a non-operating level if the temperature sensor indicates that the temperature of the first portion is above a second temperature threshold, and hold the reset input at an operating level if the temperature sensor indicates that the temperature of the first portion is below the second temperature threshold. In one example, the integrated circuit also includes a cooling output structured to be asserted if the temperature sensor indicates that the temperature of the first portion is above the second temperature threshold.

Turning now to the figures, in general, a temperature logic portion of the integrated circuit is designed to operate in a relatively wide temperature range, and a main portion of the integrated circuit is designed to operate in a relatively narrow temperature range. The narrow temperature range is preferably within the wider temperature range. The temperature logic portion of an integrated circuit allows a power supply and a clock generator to supply power and clock signals to the main portion of the integrated circuit when an on-die temperature sensor in the temperature logic portion of the integrated circuit indicates that the integrated circuit is within the narrow temperature range.

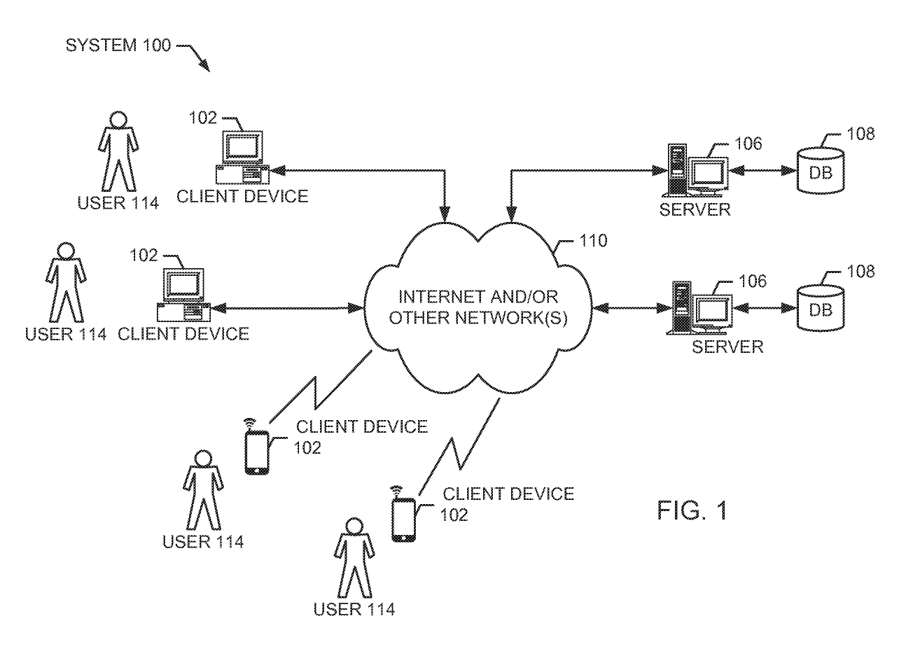

The integrated circuit may be part of a wide variety of devices. For example, the integrated circuit may be part of networked video game console. A block diagram of certain elements of an example network communications system 100 is illustrated in FIG. 1. The illustrated system 100 includes one or more client devices 102 (e.g., computer, television, camera, phone), one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102 as described in detail below. The database 108 may be connected directly to the web server 106 and/or via one or more network connections. The database 108 stores data as described in detail below.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

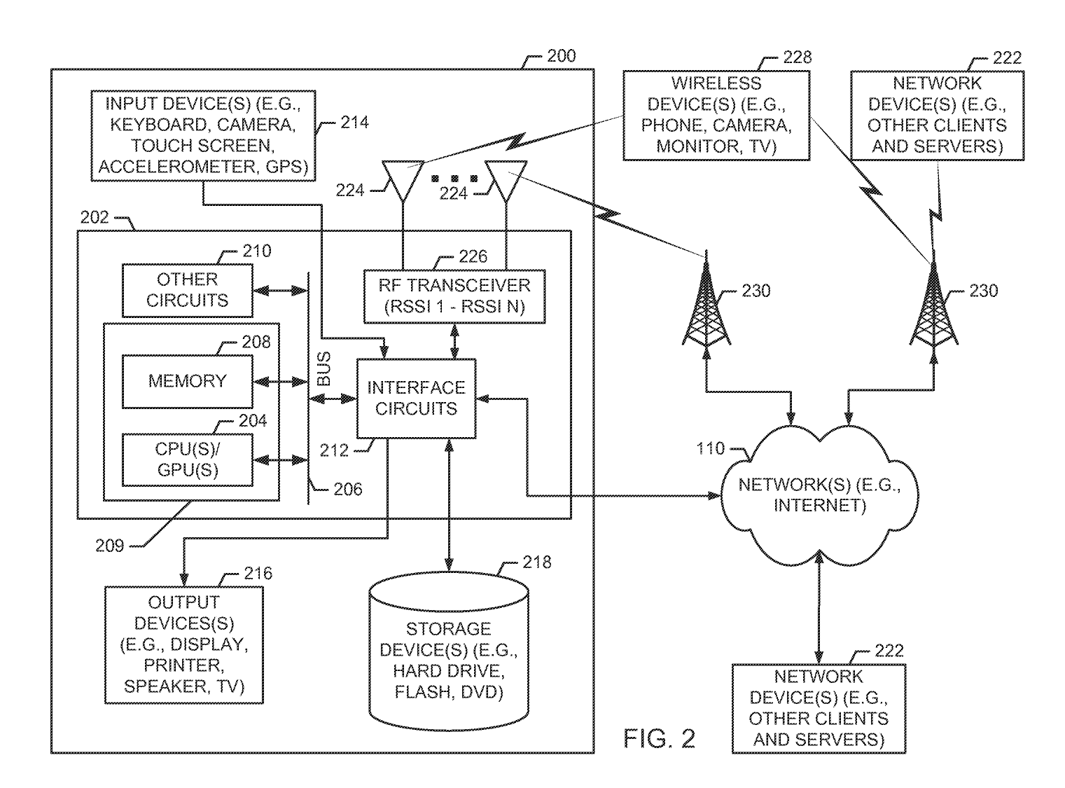

Each of the devices illustrated in FIG. 1 (e.g., client 102 and/or server 106) may include certain common aspects of many electronic devices such as microprocessors, memories, peripherals, etc. A block diagram of certain elements of an example electronic device 200 that may be include one or more integrated circuits is illustrated in FIG. 2. For example, the electrical device 200 may be a client, a server, a camera, a phone, and/or a television.

The example electrical device 200 includes a main unit 202 which may include, if desired, one or more physical processors 204 electrically coupled by an address/data bus 206 to one or more memories 208, other computer circuitry 210, and one or more interface circuits 212. The processor 204 may be any suitable processor or plurality of processors. For example, the electrical device 200 may include a central processing unit (CPU) and/or a graphics processing unit (GPU). In some embodiments, the physical processor(s) 204 are managed by a hypervisor executing a plurality of virtual processors and/or virtual machines.

The memory 208 may include various types of non-transitory memory including volatile memory and/or non-volatile memory such as, but not limited to, distributed memory, read-only memory (ROM), random access memory (RAM) etc. The memory 208 typically stores a software program that interacts with the other devices in the system as described herein. This program may be executed by the processor 204 in any suitable manner. The memory 208 may also store digital data indicative of documents, files, programs, web pages, etc. retrieved from a server and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, isopoint, camera, voice recognition system, accelerometer, global positioning system (GPS), and/or any other suitable input device.

One or more displays, printers, speakers, monitors, televisions, high definition televisions, and/or other suitable output devices 216 may also be connected to the main unit 202 via the interface circuit 212. The display 216 may be a cathode ray tube (CRTs), liquid crystal displays (LCDs), electronic ink (e-ink), and/or any other suitable type of display. The display 216 generates visual displays of data generated during operation of the device 200. For example, the display 216 may be used to display web pages and/or other content received from a server 106 and other device. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the device 200.

The electrical device 200 may also exchange data with other network devices 222 via a connection to a network 110. The network connection may be any type of network connection, such as an Ethernet connection, digital subscriber line (DSL), telephone line, coaxial cable, wireless base station 230, etc. Users 114 of the system 100 may be required to register with a server 106. In such an instance, each user 114 may choose a user identifier (e.g., e-mail address) and a password which may be required for the activation of services. The user identifier and password may be passed across the network 110 using encryption built into the user's browser. Alternatively, the user identifier and/or password may be assigned by the server 106.

In some embodiments, the device 200 may be a wireless device 200. In such an instance, the device 200 may include one or more antennas 224 connected to one or more radio frequency (RF) transceivers 226. The transceiver 226 may include one or more receivers and one or more transmitters operating on the same and/or different frequencies. For example, the device 200 may include a blue tooth transceiver 216, a Wi-Fi transceiver 216, and diversity cellular transceivers 216. The transceiver 226 allows the device 200 to exchange signals, such as voice, video and data, with other wireless devices 228, such as a phone, camera, monitor, television, and/or high definition television. For example, the device 200 may send and receive wireless telephone signals, text messages, audio signals and/or video signals directly and/or via a base station 230. A receive signal strength indicator (RSSI) associated with each receiver generates an indication of the relative strength or weakness of each signal being received by the device 200.

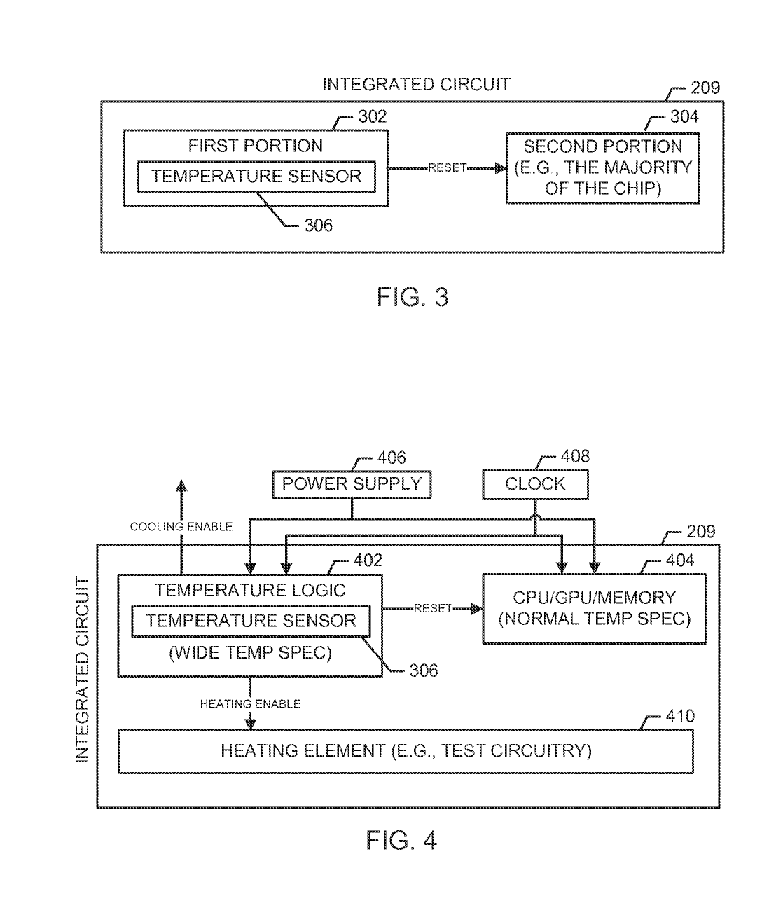

A block diagram of certain elements of an example integrated circuit 209 employing an example power up circuit is illustrated in FIG. 3. For example, the integrated circuit 209 may be one or more central processing units (CPUs), graphics processing units (GPUs), memories, application specific integrated circuits (ASICs), state machines, field programmable gate arrays (FPGAs), and/or digital signal processors (DSPs).

In this example, the integrated circuit 209 includes a first portion 302 and a second portion 304. As described below in more detail with reference to FIG. 6, the first portion may be designed to operate properly for a wider range of temperatures than the second portion. For example, the first portion 302 may be designed to operate properly from −55° C. to +125° C. (military grade), and the second portion 304 may be designed to operate properly from 0° C. to +70° C. (commercial grade).

For example, the first portion 302 may be temperature logic inside a central processing unit (CPU) and/or other circuitry designed to operate at extreme temperatures. The second portion 304 may be the rest of central processing unit (CPU) that is not designed to operate at those extreme temperatures. If the second portion 304 is allowed to operate outside of its temperature range, the second portion 304 may malfunction and/or leave the integrated circuit 209 open to a security breach.

In this example, the first portion 302 includes a temperature sensor 306. For example, the temperature sensor 306 may be an on-die temperature sensor. When the temperature sensor 306 determines that the first portion 302 of the integrated circuit 209 is within a certain temperature range, the first portion 302 of the integrated circuit 209 enables the second portion 304 of the integrated circuit 209. For example, the first portion 302 may enable a reset input on the second portion 304. In this manner, the second portion 304 of the integrated circuit 209 does not operate until the first portion 302 is within the operating temperature range of the second portion 304.

A block diagram of certain elements of another example integrated circuit 209 employing a employing an example power up circuit is illustrated in FIG. 4. For example, the integrated circuit 209 may be one or more central processing units (CPUs), graphics processing units (GPUs), memories, application specific integrated circuits (ASICs), state machines, field programmable gate arrays (FPGAs), and/or digital signal processors (DSPs).

In this example, the integrated circuit 209 includes temperature logic 402 and a central processing unit (CPU), graphics processing unit (GPU), and/or memory 404 of the integrated circuit 209. The CPU/GPU/memory 404 may be designed to operate within a certain “normal” temperature specification, whereas the temperature logic 402 may be designed to operate outside of that normal temperature specification

The temperature logic 402 also includes a temperature sensor 306. When the temperature logic 402 determines that the temperature logic portion 402 of the integrated circuit 209 is within the normal operating temperature range of the CPU/GPU/memory 404, the temperature logic 402 enables operation of the CPU/GPU/memory 404. For example, the temperature logic 402 may be holding a reset level down until the temperature logic 402 determines that the temperature measured by the temperature sensor 306 is within the normal specification for the CPU/GPU/memory 404.

At that point, the temperature logic 402 may release the reset input to CPU/GPU/memory 404, thereby allowing the CPU/GPU/memory 404 to operate. In this manner, the CPU/GPU/memory portion 404 of the integrated circuit 209 is not allowed to operate outside of the normal temperature specification for the CPU/GPU/memory 404. As a result, the CPU/GPU/memory 404 will not malfunction and/or open the integrated circuit 209 to a security issue.

In operation power supply 406 supplies power to both the temperature logic 402 and the CPU/GPU/memory 404. However the power supply lines for the temperature logic 402 may be structured to operate properly within one temperature range, and the power supply lines to the CPU/GPU/memory 404 may be structured to operate properly at some narrower temperature range. Similarly, a clock signal generator 408 may supply a clock signal to both the temperature logic 402 and the CPU/GPU/memory 404. The clock signal lines going to the temperature logic 402 may be structured to operate properly within one temperature range, and the power supply lines to the CPU/GPU/memory 404 may be structured to operate properly at some narrower temperature range.

In this example, the integrated circuit 209 includes a heating circuit 410. When the temperature logic 402 determines that the temperature sensor 306 is reading a temperature that is below the normal temperature specification for the CPU/GPU/memory 404, the temperature logic 402 may enable the heating circuit 410. For example, the heating circuit 410 may be test logic for the integrated circuit 209. When the test logic and/or other portions of the integrated circuit 209 are exercised, the integrated circuit 209 produces heat. As the temperature of the integrated circuit 209 rises due to the heating circuit 410 and/or other ambient heat sources, the temperature logic 402 continues to monitor the temperature via the temperature sensor 306. When the temperature rises to a point that it crosses a threshold that brings the CPU/GPU/memory 404 into a normal temperature range for the CPU/GPU/memory 404, the temperature logic 402 enables the reset of the CPU/GPU/memory 404, thereby allowing the CPU/GPU/memory 404 to operate.

If the temperature logic 402 determines via temperature sensor 306 that the temperature of the integrated circuit 209 is above the normal temperature specification for the CPU/GPU/memory 404, the temperature logic 402 may enable a cooling output. For example, the cooling output may enable a fan. As the fan and/or other cooling elements run, the temperature logic 402 continues to monitor the temperature via the temperature sensor 306. When the temperature logic 402 determines that the temperature of the integrated circuit 209 has cooled down to a level that is within the normal temperature specifications for the CPU/GPU/memory 404, the temperature logic 402 enables the CPU/GPU/memory 404 via the reset line.

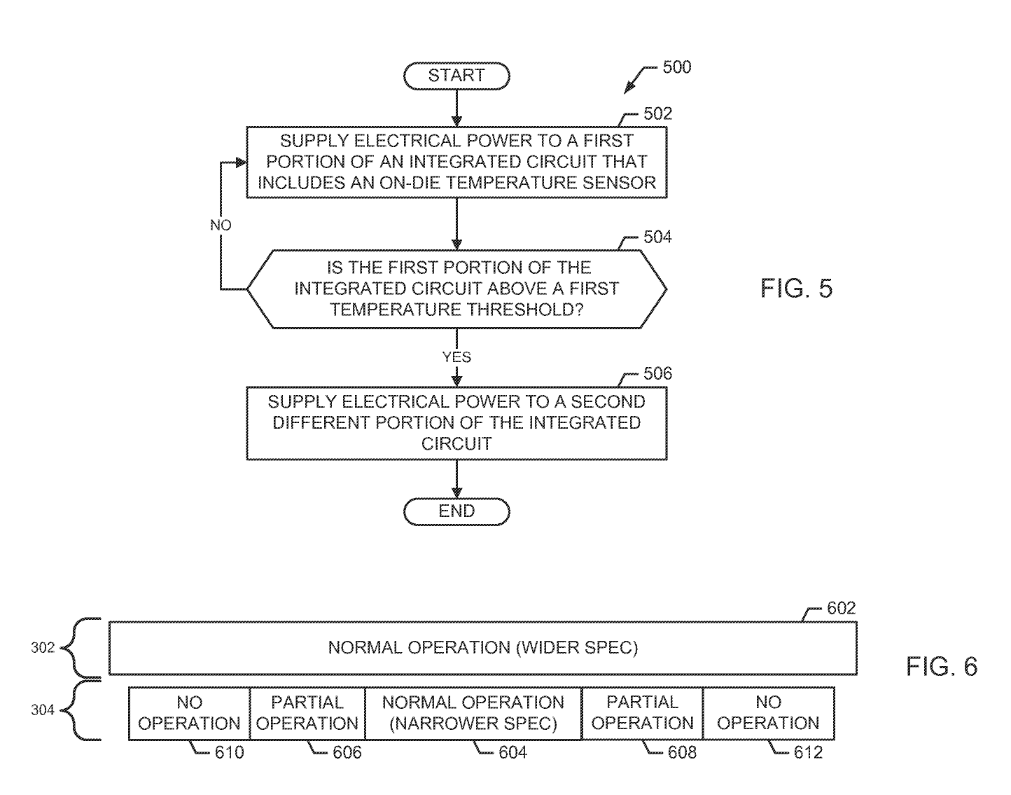

A flowchart of an example process 500 for powering up an integrated circuit is illustrated in FIG. 5. Although the process 500 is described with reference to the flowchart illustrated in FIG. 5, it will be appreciated that many other methods of performing the acts associated with process 500 may be used. For example, the order of many of the operations may be changed, and some of the operations described may be optional.

The process 500 begins when the power supply 406 supplies electrical power to the first portion 302 of the integrated circuit 209 (block 502). The first portion 302 includes an on-die temperature sensor 306. If the first portion 302 of the integrated circuit 209 is above a first temperature threshold (block 504), the power supply 406 also supplies electrical power to the second portion 304 of the integrated circuit 209 (block 506). However, if the first portion 302 of the integrated circuit 209 is not above the first temperature threshold, the power supply 406 continues to only supply electrical power to the first portion 302 of the integrated circuit 209.

For example, the first portion 302 may be designed to operate properly from −55° C. to +125° C., and the second portion 304 may be designed to operate properly from 0° C. to +70° C. (commercial grade). Accordingly, in this example, the temperature threshold may be set to 0° C. (or slightly higher). When the on-die temperature sensor 306 indicates that the temperature is less than 0° C., power is inly delivered to the first portion 302 of the integrated circuit 209. When the on-die temperature sensor 306 indicates that the temperature is more than 0° C., power is delivered to the second portion 302 of the integrated circuit 209. In this manner, the integrated circuit is less likely to malfunction and/or create a security problem.

FIG. 6 is a block diagram of example temperature specifications for two different portions 302, 304 of the integrated circuit 209. In this example, the first portion 302 of the integrated circuit 209 is designed to operate in a wide temperature range 602. The second portion 304 of the integrated circuit 209 is designed to operate in a narrower temperature range 604. For example, the first portion 302 may be designed to operate properly from −55° C. to +125° C. (military grade), and the second portion 304 may be designed to operate properly from 0° C. to +70° C. (commercial grade). In another example, the first portion 302 may be designed to operate properly from −55° C. to +125° C. (military grade), and the second portion 304 may be designed to operate properly from −40° C. to +85° C. (industrial grade). In yet another example, the first portion 302 may be designed to operate properly from −40° C. to +85° C. (industrial grade), and the second portion 304 may be designed to operate properly from 0° C. to +70° C. (commercial grade).

If the second portion 304 of the integrated circuit 209 operates slightly below 606 or slightly above 608 the normal operating temperature 604, that portion 304 of integrated circuit 209 may only partially operate. In these temperature ranges of partial operation 606, 608, the second portion 304 of the integrated circuit 209 main malfunction and open the integrated circuit 209 up to one or more security issue. At even lower temperatures 610 and even higher temperatures 612, the second portion 304 of the integrated circuit 209 may not operate at all.

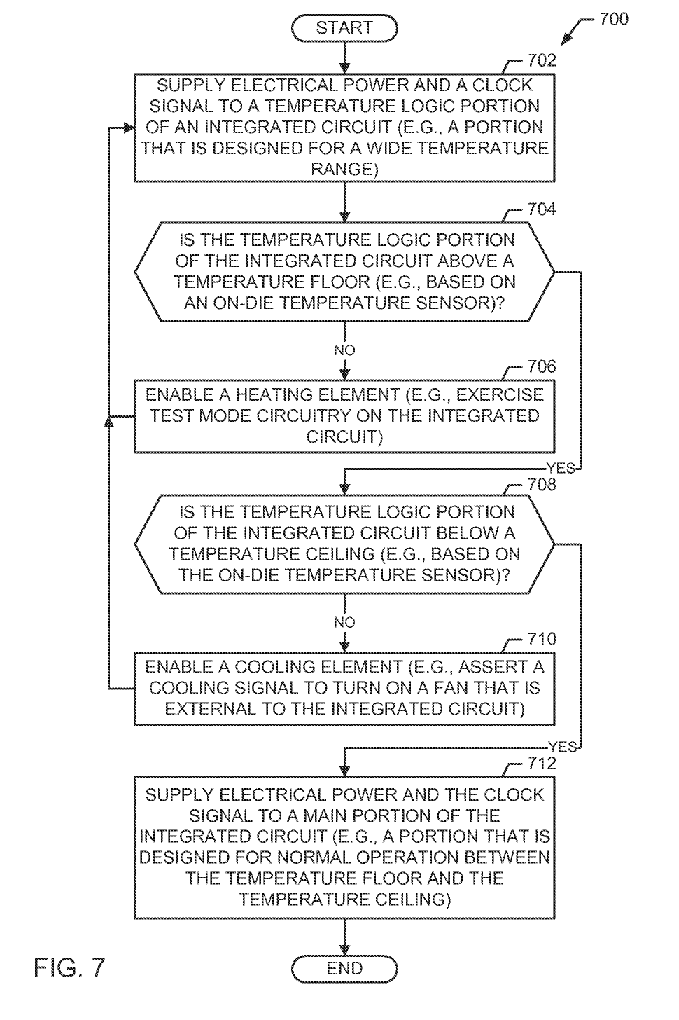

FIG. 7 is a flowchart of another example process for powering up an integrated circuit. Although the process 700 is described with reference to the flowchart illustrated in FIG. 7, it will be appreciated that many other methods of performing the acts associated with process 500 may be used. For example, the order of many of the operations may be changed, and some of the operations described may be optional.

In general, a temperature logic portion 402 of the integrated circuit 209 is designed to operate in a relatively wide temperature range 602, and a main portion 404 of the integrated circuit 209 is designed to operate in a relatively narrow temperature range 604. The narrow temperature range 604 is preferably within the wider temperature range 602. The temperature logic portion 402 of an integrated circuit 209 allows a power supply 406 and a clock generator 408 to supply power and clock signals to the main portion 404 of the integrated circuit 209 when an on-die temperature sensor 306 in the temperature logic portion 402 of the integrated circuit 209 indicates that the integrated circuit 209 is within the narrow temperature range 604.

More specifically, in this example, the process 700 begins when the power supply 406 and the clock generator 408 supply power and clock signals to the temperature logic portion 402 of an integrated circuit 209 (block 702). For example, the temperature logic portion 402 of the integrated circuit 209 may be designed for a wide temperature range 602 (e.g., −55° C. to +125° C.).

If the temperature of the logic portion 402 of the integrated circuit 209 is below a temperature floor (block 704), the temperature logic portion 402 may enable a heating element (block 706). For example, the on-die temperature sensor 306 may determine that the temperature of the integrated circuit 209 is below a floor of 0° C. and exercise test circuitry located on the integrated circuit 209 to heat the integrated circuit 209.

If the temperature of the integrated circuit 209 is above the temperature floor (e.g., 0° C.), the temperature logic portion 402 determines if the temperature of the integrated circuit 209 is below a temperature ceiling (block 708). If the temperature is above the temperature ceiling, the temperature logic 402 may enable a cooling element (block 710). For example, the on-die temperature sensor 306 may determine that the temperature of the integrated circuit 209 is above a ceiling of 70° C. and assert a cooling signal to turn on a fan that is external to the integrated circuit 209.

If the temperature of the integrated circuit 209 is below the temperature ceiling (e.g., 70° C.), the power supply 406 and the clock signal generator 408 may supply electrical power and a clock signal to the main portion 404 of the integrated circuit 209 (block 712). For example, the main portion of integrated circuit 209 may be a CPU, GPU, and/or memory that is designed for normal operation between the temperature floor (e.g., 0° C.) and the temperature ceiling (e.g., 70° C.).

In summary, persons of ordinary skill in the art will readily appreciate that methods and apparatus for powering up an integrated circuit have been provided. Among other features, integrated circuits that power up different portions of the integrated circuit at different times (e.g., after self-heating) as described herein are less likely to malfunction and/or create a security problem by operating at a temperature where the integrated circuit only partially functions.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of operating a computing device, the method comprising:
supplying electrical power to a first portion of a first integrated circuit, the first portion including a temperature sensor; and
supplying electrical power to a second integrated circuit in response to the temperature sensor detecting that a temperature of the first portion is above a first temperature threshold.

2. The method of claim 1 wherein the second integrated circuit forms a second and different portion of the first integrated circuit.

3. The method of claim 1, further comprising heating the integrated circuit by enabling a heating element in response to an indication from the temperature sensor that the temperature of the first portion is below the first temperature threshold.

4. The method of claim 3, wherein the heating element includes a third portion of the integrated circuit, and the third portion of the integrated circuit includes test mode circuitry.

5. The method of claim 1, wherein supplying electrical power to the second portion of the integrated circuit is also in response to an indication from the first portion of the integrated circuit that the temperature of the first portion is below a second temperature threshold.

6. The method of claim 5, further comprising cooling the integrated circuit by enabling a cooling element in response to an indication from the temperature sensor that the temperature of the first portion is above the second temperature threshold.

7. The method of claim 1, further comprising:
supplying a clock signal to the first portion of the integrated circuit, and
supplying the clock signal to the second portion of the integrated circuit in response to the temperature sensor detecting that the temperature of the first portion is above the first temperature threshold.

8. The method of claim 7, wherein supplying the clock signal to the second different portion of the integrated circuit is also in response to the temperature sensor detecting that the temperature of the first portion is below a second temperature threshold.

9. A method of operating a computing device, the method comprising:
supplying electrical power to a first portion of a first integrated circuit, wherein the first portion of the integrated circuit is constructed to operate within a first temperature range; and
supplying electrical power to a second integrated circuit in response to an indication from the first portion of the integrated circuit that a temperature of the first portion is in a second temperature range, the second temperature range being within the first temperature range.

10. The method of claim 9, further comprising heating the integrated circuit by enabling a heating element in response to an indication that the temperature of the first portion is below the second temperature range.

11. The method of claim 10, wherein the heating element includes a third portion of the integrated circuit, and the third portion of the integrated circuit includes test mode circuitry.

12. The method of claim 9, further comprising cooling the integrated circuit by enabling a cooling element in response to an indication that the temperature of the first portion is above the second temperature range.

13. The method of claim 9, further comprising:
supplying a clock signal to the first portion of the integrated circuit, and
supplying the clock signal to the second portion of the integrated circuit in response to the indication that the temperature of the first portion is in the second temperature range.

14. A method of powering up an integrated circuit, the method comprising:
supplying electrical power and a clock signal to a first portion of the integrated circuit, wherein the first portion of the integrated circuit is constructed to operate within a first temperature range;
determining if a temperature of the first portion is in a second temperature range, the second temperature range being within the first temperature range;
enabling at least one of a heating element and a cooling element in response to determining if the temperature of the first portion is in a second temperature range;
waiting until the first portion of the integrated circuit generates an indication that the temperature of the first portion is in a second temperature range, the second temperature range being within the first temperature range; and
supplying electrical power and the clock signal to a second different portion of the integrated circuit in response to the indication that the temperature of the first portion is in the second temperature range.

15. The method of claim 14, wherein the heating element includes a third portion of the integrated circuit.

16. An integrated circuit comprising:
a first portion including a temperature sensor; and
a second portion including a reset input, wherein the first portion is structured to (a) hold the reset input at a non-operating level if the temperature sensor indicates that a temperature of the first portion is below a first temperature threshold, and (b) hold the reset input at an operating level if the temperature sensor indicates that the temperature of the first portion is above the first temperature threshold.

17. The integrated circuit of claim 16, further comprising a heating element structured to heat the first portion and the second portion if the temperature sensor indicates that the temperature of the first portion is below the first temperature threshold.

18. The integrated circuit of claim 16, wherein the second portion is further structured to (c) hold the reset input at a non-operating level if the temperature sensor indicates that the temperature of the first portion is above a second temperature threshold, and (d) hold the reset input at an operating level if the temperature sensor indicates that the temperature of the first portion is below the second temperature threshold.

19. The integrated circuit of claim 18, further comprising a cooling output structured to be asserted if the temperature sensor indicates that the temperature of the first portion is above the second temperature threshold.

20. An integrated circuit comprising:
a first portion including a temperature sensor, the first portion being constructed to operate within a first temperature range; and
a second portion including a reset input, the second portion being constructed to operate within a second temperature range, the second temperature range being within the first temperature range, wherein the first portion is structured to hold the reset input at a non-operating level if the temperature sensor indicates that a temperature of the first portion is outside the second temperature range, and the first portion is structured to hold the reset input at an operating level if the temperature sensor indicates that the temperature of the first portion is within the second temperature range.

21. The integrated circuit of claim 20, further comprising a heating element structured to heat the first portion and the second portion if the temperature sensor indicates that the temperature of the first portion is below the first temperature range.

22. The integrated circuit of claim 20, further comprising a cooling output structured to be asserted if the temperature sensor indicates that the temperature of the first portion is above the second temperature range.
